(19) United States
(12) Patent Application Publication
(10) Pub. No.: US 2017/0126847 A1
(43) Pub. Date: May 4, 2017

(54) COMMUNICATION SYSTEM AND COMMUNICATION METHOD

(71) Applicant: ANRITSU NETWORKS CO., LTD., Atsugi-shi (JP)

(72) Inventors: Kenji Anzai, Atsugi-shi (JP); Takayuki Sato, Tokyo (JP)

(21) Appl. No.: 15/340,159

(22) Filed: Nov. 1, 2016

(30) Foreign Application Priority Data
Nov. 4, 2015 (JP) 2015-216631

(51) Int. Cl. H04L 29/06

(52) U.S. Cl. CPC H04L 69/16; H04L 69/22

(57) ABSTRACT

An object of the present invention is to perform long-distance TCP/IP transfer at a high throughput and in a short period of time. According to the present invention, in a communication system in which transmission data is transferred using a transmission-side TCP device and a receiving-side TCP device, the transmission-side TCP device includes a plurality of first IP processing units, a plurality of first TCP processing units, a plurality of compression processing units, a plurality of second TCP processing units, and a plurality of second IP processing units. The receiving-side TCP device includes a plurality of third IP processing units, a plurality of third TCP processing units, a plurality of decompression processing units, a plurality of fourth TCP processing units, and a plurality of fourth IP processing units. The respective units perform processing independently of and in parallel with each other.

### TECHNICAL FIELD

The present invention relates to a communication system and a communication method for performing Transmission Control Protocol/Internet Protocol (TCP/IP) communication.

### BACKGROUND ART

In a case where TCP/IP communication is performed, as shown in FIG. 1, a terminal C establishes a session with a terminal S, and then transfers data to the terminal S while performing confirmation of delivery by receiving an ACK from the terminal S. On the other hand, the communication capacity of data has tended to increase every year. Particularly, a backup of a server has tended to be installed in a long-distance area for the purpose of diversification of risk.

In a case where there is a physical distance between the terminal C and the terminal S, the transfer delay time of a packet increases. Therefore, when TCP/IP transfer over long-distance intervals is performed, the throughput of TCP/IP communication decreases as a matter of course. For this reason, there is a problem in that the backup of a server requires time, and it takes time to perform synchronization between servers.

In order to solve such a problem, as shown in FIG. 2, an invention is proposed in which a TCP device W1 and a TCP device W2 are provided between a terminal C and a terminal S, and the TCP device W1 and the TCP device W2 perform a proxy response (see, for example, Patent Document 1). In the invention of Patent Document 1, the TCP device W1 transmits an ACK to the terminal C instead of the terminal S, and the TCP device W2 transmits an ACK to the terminal S instead of the terminal C. Thereby, a decrease in the throughput of TCP/IP communication which is caused by the transfer delay time of a packet is prevented from occurring.

### RELATED ART DOCUMENT

### Patent Document

[Patent Document 1] JP-A-7-177177

### DISCLOSURE OF THE INVENTION

### Problem that the Invention is to Solve

The TCP devices W1 and W2 of Patent Document 1 are connected to the boundary of a WAN with a large number of terminals, and have to perform processing of a session established in each of the terminals. In a case where the speed of a physical interface is low (for example, 1 Gbit/s), the TCP devices W1 and W2 also have a small number of TCP sessions to be processed and have been used without any problem. However, in a case where the speed of a physical interface becomes higher (for example, 10 Gbit/s×4), it is necessary to handle a large number of TCP sessions, and the processing capabilities of the TCP devices W1 and W2 become a bottleneck, which results in the incapability of data transfer at a high throughput.

Consequently, an object of the present invention is to perform long-distance TCP/IP transfer at a high throughput and in a short period of time.

### Means for Solving the Problem

In order to achieve the above object, a communication system of the present invention is configured such that a data queue that stores processed data for each session is provided in TCP devices W1 and W2, and that data stored in the data queue is read out to perform pieces of processing in respective layers independently of and in parallel with each other.

Specifically, according to the present invention, there is provided a transmission-side TCP device in a communication system in which transmission data which is transmitted using TCP/IP from a transmission terminal to a receiving terminal is transferred using the transmission-side TCP device and a receiving-side TCP device, the device including: a plurality of first IP processing units that determine whether a packet transmitted from the transmission terminal is a TCP/IP packet transmitted in accordance with TCP/IP, and specify a session of TCP/IP in a case of a TCP/IP packet; a first data queue in the transmission-side TCP device that accumulates the packet, determined to be a TCP/IP packet by the first IP processing unit, for each session; a plurality of first TCP processing units that read out the packet accumulated in the first data queue in transmission-side TCP device, and perform TCP processing on the packet with the transmission terminal; a second data queue in the transmission-side TCP device that accumulates transmission data, included in the packet on which the TCP processing has been performed by the first TCP processing unit, for each session; a plurality of compression processing units in the transmission-side TCP device that read out the transmission data accumulated in the second data queue in the transmission-side TCP device, and perform compression processing on the transmission data; a third data queue in the transmission-side TCP device that accumulates the transmission data, compressed by the compression processing unit in the transmission-side TCP device, for each session; a plurality of second TCP processing units that read out the compressed transmission data accumulated in the third data queue in the transmission-side TCP device, and perform TCP processing with the receiving-side TCP device for transmitting the transmission data to the receiving-side TCP device; a fourth data queue in the transmission-side TCP device that accumulates the transmission data, on which the TCP processing has been performed by the second TCP processing unit, for each session; and a plurality of second IP processing units that generate a packet obtained by performing IP processing for transmitting the transmission data accumulated in the fourth data queue in the transmission-side TCP device to the receiving-side TCP device.

Specifically, according to the present invention, there is provided a receiving-side TCP device in a communication system in which transmission data which is transmitted using TCP/IP from a transmission terminal to a receiving terminal is transferred using a transmission-side TCP device and the receiving-side TCP device, the device including: a plurality of third IP processing units that determine whether a packet transmitted from the transmission-side TCP device is a TCP/IP packet transmitted in accordance with TCP/IP, and specify a session of TCP/IP in a case of a TCP/IP packet; a first data queue in the receiving-side TCP device that accumulates the packet, determined to be a TCP/IP packet by the third IP processing unit, for each session; a plurality of third TCP processing units that read out the packet accumulated in the first data queue in the receiving-side TCP device, and perform TCP processing on the packet with the transmission-side TCP device; a second data queue in the receiving-side TCP device that accumulates transmission data, included in the packet on which the TCP processing has been performed by the third TCP processing unit, for each session; a plurality of decompression processing units in the receiving-side TCP device that read out the transmission data accumulated in the second data queue in the receiving-side TCP device, and perform decompression processing on the transmission data; a third data queue in the receiving-side TCP device that accumulates the transmission data, decompressed by the decompression processing unit in the receiving-side TCP device, for each session; a plurality of fourth TCP processing units that read out the decompressed transmission data accumulated in the third data queue in the receiving-side TCP device, and perform TCP processing with the receiving terminal for transmitting the transmission data to the receiving terminal; a fourth data queue in the receiving-side TCP device that accumulates the transmission data, on which the TCP processing has been performed by the fourth TCP processing unit, for each session; and a plurality of fourth IP processing units that generate a packet obtained by performing IP processing for transmitting the transmission data accumulated in the fourth data queue in the receiving-side TCP device to the receiving terminal.

Specifically, according to the present invention, there is provided a communication system including the transmission-side TCP device and the receiving-side TCP device according to the present invention.

Specifically, according to the present invention, there is provided a communication method in which transmission data which is transmitted using TCP/IP from a transmission terminal to a receiving terminal is transferred using a transmission-side TCP device and a receiving-side TCP device, the method including, in the following order: a first IP processing procedure of causing the transmission-side TCP device to determine whether a packet transmitted from the transmission terminal is a TCP/IP packet transmitted in accordance with TCP/IP, specify a session of TCP/IP in a case of a TCP/IP packet, and to accumulate the packet determined to be a TCP/IP packet in a first data queue in the transmission-side TCP device for each session; a first TCP processing procedure of causing the transmission-side TCP device to read out the packet accumulated in the first data queue in the transmission-side TCP device, perform TCP processing on the packet with the transmission terminal, and to accumulate transmission data, included in the packet on which the TCP processing has been performed, in a second data queue in the transmission-side TCP device for each session; a compression processing procedure in the transmission-side TCP device of causing the transmission-side TCP device to read out the transmission data accumulated in the second data queue in the transmission-side TCP device, perform compression processing on the transmission data, and to accumulate the compressed transmission data in a third data queue in the transmission-side TCP device for each session; a second TCP processing procedure of causing the transmission-side TCP device to read out the compressed transmission data accumulated in the third data queue in the transmission-side TCP device, perform TCP processing with the receiving-side TCP device for transmitting the transmission data to the receiving-side TCP device, and to accumulate the transmission data, on which the TCP processing has been performed, in a fourth data queue in the transmission-side TCP device for each session; a second IP processing procedure of causing the transmission-side TCP device to generate a packet obtained by performing IP processing for transmitting the transmission data accumulated in the fourth data queue in the transmission-side TCP device to the receiving-side TCP device, and to transmit the packet to the receiving-side TCP device; a third IP processing procedure of causing the receiving-side TCP device to determine whether a packet transmitted from the transmission-side TCP device is a TCP/IP packet transmitted in accordance with TCP/IP, specify a session of TCP/IP in a case of a TCP/IP packet, and to accumulate the packet determined to be a TCP/IP packet in a first data queue in the receiving-side TCP device for each session; a third TCP processing procedure of causing the receiving-side TCP device to read out the packet accumulated in the first data queue in the receiving-side TCP device, perform TCP processing on the packet with the transmission-side TCP device, and to accumulate transmission data, included in the packet on which the TCP processing has been performed, in a second data queue in the receiving-side TCP device for each session; a decompression processing procedure in the receiving-side TCP device of causing the receiving-side TCP device to read out the transmission data accumulated in the second data queue in the receiving-side TCP device, perform decompression processing on the transmission data, and to accumulate the decompressed transmission data in a third data queue in the receiving-side TCP device for each session; a fourth TCP processing procedure of causing the receiving-side TCP device to read out the decompressed transmission data accumulated in the third data queue in the receiving-side TCP device, perform TCP processing with the receiving terminal for transmitting the transmission data to the receiving terminal, and to accumulate the transmission data, on which the TCP processing has been performed, in a fourth data queue in the receiving-side TCP device for each session; and a fourth IP processing procedure of causing the receiving-side TCP device to generate a packet obtained by performing IP processing for transmitting the transmission data accumulated in the fourth data queue in the receiving-side TCP device to the receiving terminal, and to transmit the packet to the receiving terminal.

### Advantage of the Invention

According to the present invention, a data queue that stores processed data for each session is provided in TCP devices W1 and W2, and data stored in the data queue is read out to subdivide pieces of processing in respective layers and perform the pieces of processing independently of and in parallel with each other. Therefore, it is possible to perform long-distance TCP/IP transfer at a high throughput and in a short period of time.

### BRIEF DESCRIPTION OF THE DRAWINGS

FIG. 1 shows an example of a data transfer method using TCP/IP communication.

FIG. 2 shows an example of a data transfer method which is proposed in Patent Document 1.

FIG. 3 shows a configuration example of a transmission-side TCP device.

FIG. 4 shows a configuration example a receiving-side TCP device.

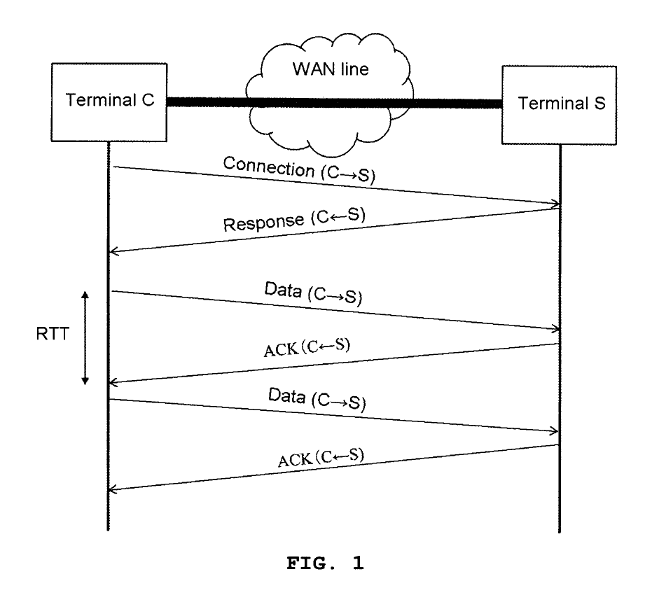

### BEST MODE FOR CARRYING OUT THE INVENTION

Hereinafter, an embodiment of the present invention will be described in detail with reference to the accompanying drawings. Meanwhile, the present invention is not limited to an embodiment shown below. The embodiment is merely illustrative, and the present invention can be embodied in various forms on which changes and modifications have been performed, on the basis of the knowledge of those skilled in the art. Meanwhile, components having the same reference numerals and signs in the present specification and the accompanying drawings are assumed to be the same as each other.

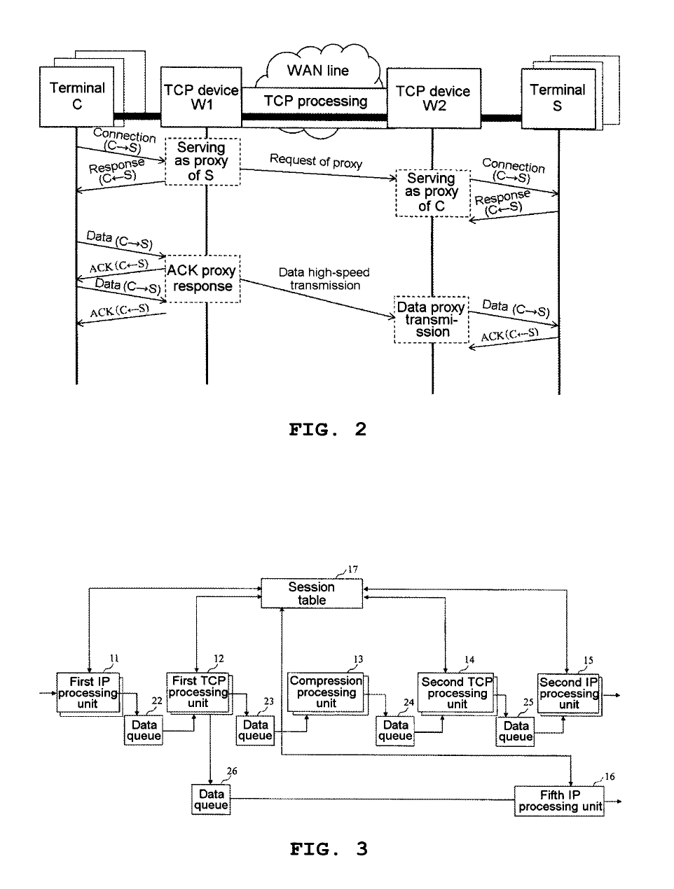

A packet transfer system according to the embodiment of the present invention includes a transmission-side TCP device and a receiving-side TCP device. The transmission-side TCP device functions as a TCP device W1 shown in FIG. 2. The receiving-side TCP device functions as a TCP device W2 shown in FIG. 2. The transmission-side TCP device is connected to a plurality of terminals C, and transmits and receives a packet based on TCP/IP to and from each of the terminals C. The receiving-side TCP device is connected to a plurality of terminals S, and transmits and receives a packet based on TCP/IP to and from each of the terminals S.

FIG. 3 shows an example of the transmission-side TCP device according to the embodiment of the present invention. The transmission-side TCP device according to the present embodiment includes first and fifth IP processing units 11 and 16, first TCP processing units 12, compression processing units 13, second TCP processing units 14, second IP processing units 15, and a session table 17. The numbers of first and fifth IP processing units 11 and 16, first TCP processing units 12, compression processing units 13, second TCP processing units 14 and second IP processing units 15 are plural, respectively, and the respective units perform processing independently of each other.

In addition, the transmission-side TCP device includes data queues 22, 23, 24, 25, and 26 for each session. The data queues 22, 23, 24, and 25 function as first to fourth data queues in the transmission-side TCP device, respectively.

The session table 17 is stored in a storage unit (not shown). The transmission-side TCP device according to the present embodiment may be realized by causing a computer to function as the first and fifth IP processing units 11 and 16, the first TCP processing unit 12, the compression processing unit 13, the second TCP processing unit 14 and the second IP processing unit 15. In this case, a central processing unit (CPU) in the transmission-side TCP device executes a computer program stored in a storage unit (not shown), to thereby realize each configuration.

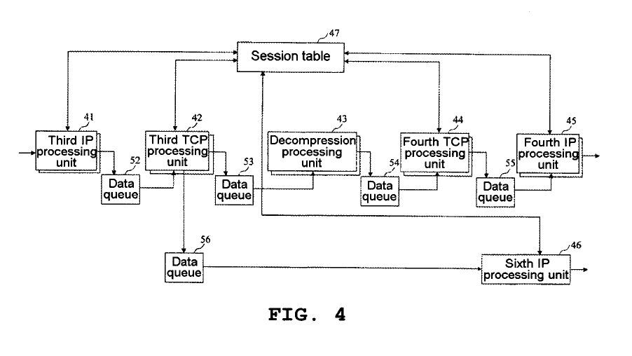

FIG. 4 shows an example of the receiving-side TCP device according to the embodiment of the present invention. The receiving-side TCP device according to the present embodiment includes third IP processing units 41, third TCP processing units 42, decompression processing units 43, fourth TCP processing units 44, fourth and sixth IP processing units 45 and 46, and a session table 47. The numbers of third IP processing units 41, third TCP processing units 42, decompression processing units 43, fourth TCP processing units 44 and fourth IP processing units 45 are plural, respectively, and the respective units perform processing independently of each other.

In addition, the receiving-side TCP device includes data queues 52, 53, 54, 55, and 56 for each session. The data queues 52, 53, 54, and 55 function as data queues in first to fourth receiving-side TCP devices.

The session table 47 is stored in a storage unit (not shown). The receiving-side TCP device according to the present embodiment may be realized by causing a computer to function as the third IP processing unit 41, the third TCP processing unit 42, the decompression processing unit 43, the fourth TCP processing unit 44 and the fourth IP processing unit 45. In this case, a central processing unit (CPU) in the receiving-side TCP device executes a computer program stored in a storage unit (not shown), to thereby realize each configuration.

A communication method according to the embodiment of the present invention is a communication method of transferring transmission data, transmitted using TCP/IP from the terminal C to the terminal S, using the transmission-side TCP device and the receiving-side TCP device. The communication method according to the embodiment of the present invention includes a first IP processing procedure, a first TCP processing procedure, a compression processing procedure in the transmission-side TCP device, a second TCP processing procedure, a second IP processing procedure, a third IP processing procedure, a third TCP processing procedure, a decompression processing procedure in the receiving-side TCP device, a fourth TCP processing procedure, and a fourth IP processing procedure, in this order.

A packet sent out from the terminal C to a LAN is input to the first IP processing unit 11. In a case where packets are continuously input to the transmission-side TCP device, the respective packets are input to the different first IP processing units 11, respectively. Then, the transmission-side TCP device performs the first IP processing procedure.

In the first IP processing procedure, the first IP processing unit 11 determines whether the packet received from the terminal C is a TCP/IP packet, and specifies a session in a case of the TCP/IP packet. The first IP processing unit 11 accumulates data of a packet specified by a session in the data queue 22.

Here, a session is specified on the basis of, for example, information stored in the session table 17. The information stored in the session table 17 is, for example, a transmission source IP address, a destination IP address, a transmission source port number and a destination port number.

When data is accumulated in the data queue 22, the transmission-side TCP device performs the first TCP processing procedure. In the first TCP processing procedure, the first TCP processing unit 12 reads out data from the data queue 22, and performs TCP processing between the terminal C and the terminal S. In this case, the first TCP processing unit 12 performs the TCP processing between the terminals C instead of the terminal S. The plurality of first TCP processing units 12 operate independently of each other, and sequentially perform session processing.

In a case where a packet is a connection request of a session, the first TCP processing unit 12 accumulates data of the packet in the data queue 24 established by the session.

In a case where a packet is data transmission of a session, the first TCP processing unit 12 accumulates data of a packet after the TCP processing is completed in the data queue 23, and accumulates proxy response data in the data queue 26.

When the data is accumulated in the data queue 23, the transmission-side TCP device performs the compression processing procedure in the transmission-side TCP device. In the compression processing procedure in the transmission-side TCP device, the compression processing unit 13 reads out data from the data queue 23, and compresses the data. Thereby, data in the direction of a WAN is compressed. The compression processing unit 13 accumulates the data after compression in the data queue 24 established by a session.

When the data is accumulated in the data queue 24, the transmission-side TCP device performs the second TCP processing procedure. In the second TCP processing procedure, the second TCP processing unit 14 reads out data of a designated session from the data queue 24, and performs the TCP processing with the receiving-side TCP device. The second TCP processing unit 14 accumulates the data after TCP processing in the data queue 25 established by a session.

In this case, in a case where the packet accumulated in the data queue 24 is a connection request of a session, the second TCP processing unit 14 performs a connection request for the receiving-side TCP device. In this case, the second TCP processing unit 14 refers to the session table 17, and sends session information to the receiving-side TCP device.

In a case where the packet accumulated in the data queue 24 is data transmission of a session, the second TCP processing unit 14 transmits compressed data to the receiving-side TCP device. For example, the second TCP processing unit 14 refers to the session table 17, and sends session information to the receiving-side TCP device.

When the data is accumulated in the data queue 25, the transmission-side TCP device performs the second IP processing procedure. In the second IP processing procedure, the second IP processing unit 15 reads out data of a designated session from the data queue 25, and generates a packet for transmitting the read-out data to the receiving-side TCP device. Thereby, a packet transmitted from the terminal C is transmitted toward the receiving-side TCP device.

When the data is accumulated in the data queue 26, the transmission-side TCP device performs the first response processing procedure. In the first response processing procedure, the fifth IP processing unit 16 reads out data of a designated session from the data queue 26, generates a packet for TCP processing with the terminal C, and transmits the packet to the terminal C.

The operations of the compression processing unit 13, the second TCP processing unit 14, and the second IP processing unit 15 and the operation of the fifth IP processing unit 16 are subdivided and performed independently of each other, with respect to a common session. Therefore, the transmission-side TCP device can transmit data to the receiving-side TCP device without waiting for the TCP processing with the terminal C. In addition, since the operation of the first TCP processing unit 12 is managed by the data queue 22, the first TCP processing unit 12 can immediately start the TCP processing when a session can be specified. Therefore, the transmission-side TCP device can rapidly perform a packet to the receiving-side TCP device.

The packet sent out from the transmission-side TCP device is input to the third IP processing unit 41. In a case where packets are continuously input to the receiving-side TCP device, the respective packets are input to the different third IP processing units 41, respectively.

When the packet is input to the third IP processing unit 41, the receiving-side TCP device performs the third IP processing procedure. In the third IP processing procedure, the third IP processing unit 41 determines whether the packet received from the transmission-side TCP device is a TCP/IP packet, and specifies a session in a case of a TCP/IP packet. The third IP processing unit 41 accumulates data of a packet specified by a session in the data queue 52.

Here, a session is specified on the basis of, for example, information stored in the session table 47. The information stored in the session table 47 is, for example, a transmission source IP address, a destination IP address, a transmission source port number and a destination port number.

When the data is accumulated in the data queue 52, the receiving-side TCP device performs the third TCP processing procedure. In the third TCP processing procedure, the third TCP processing unit 42 reads out data of a designated session from the data queue 52, and performs the TCP processing between the processing unit and the transmission-side TCP device. Here, the plurality of third TCP processing units 42 operate independently of each other, and sequentially perform session processing accumulated in the data queue 52.

In a case where a packet is a connection request of a session, the third TCP processing unit 42 accumulates data of the packet in the data queue 56 established by the session.

In a case where a packet is data transmission of a session, the third TCP processing unit 42 accumulates data of a packet after the TCP processing is completed in the data queue 53.

When the data is accumulated in the data queue 53, the receiving-side TCP device performs the decompression processing procedure in the receiving-side TCP device. In the decompression processing procedure in the receiving-side TCP device, the decompression processing unit 43 reads out data of a designated session from the data queue 53, and decompresses the data. Thereby, the data from the terminal C to the terminal S is decompressed. The decompression processing unit 43 accumulates the data after decompression in the data queue 54 established by a session.

When the data is accumulated in the data queue 54, the receiving-side TCP device performs the fourth TCP processing procedure. In the fourth TCP processing procedure, the fourth TCP processing unit 44 reads out data of a designated session from the data queue 54, and performs the TCP processing with the terminal S. The fourth TCP processing unit 44 accumulates the data after TCP processing in the data queue 55 established by a session.

When the data is accumulated in the data queue 55, the receiving-side TCP device performs the fourth IP processing procedure. In the fourth IP processing procedure, the fourth IP processing unit 45 reads out data of a designated session from the data queue 55, and generates a packet for transmitting the read-out data to the terminal S. In this case, the fourth IP processing unit 45 reads out information of the designated session from the session table 47, and loads the information into a packet. Thereby, the packet transmitted from the receiving-side TCP device is transmitted toward the terminal S.

When the data is accumulated in the data queue 56, the sixth IP processing unit 46 performs a request for connection to the terminal S instead of the terminal C, on the basis of the session information sent from the transmission-side TCP device W1.

The operations of the decompression processing unit 43, the fourth TCP processing unit 44 and the fourth IP processing unit 45 are performed independently of each other with respect to a common session. Therefore, the receiving-side TCP device can transmit data to the terminal S without waiting for the TCP processing with the terminal C. In addition, since the operation of the third TCP processing unit 42 is managed by the data queue 52, the third TCP processing unit 42 can immediately start the TCP processing when a session can be specified. Therefore, the receiving-side TCP device can rapidly perform a packet to the terminal S.

### INDUSTRIAL APPLICABILITY

The present invention can be applied to the information communication industry.

### DESCRIPTION OF REFERENCE NUMERALS AND SIGNS

11: First IP processing unit
12: First TCP processing unit
13: Compression processing unit
14: Second TCP processing unit
15: Second IP processing unit
16: Fifth IP processing unit
17, 47: Session table
41: Third IP processing unit
42: Third TCP processing unit
43: Decompression processing unit
44: Fourth TCP processing unit
45: Fourth IP processing unit

What is claimed is:

1. A transmission-side TCP device in a communication system in which transmission data which is transmitted using Transmission Control Protocol/Internet Protocol (TCP/IP) from a transmission terminal to a receiving terminal is transferred using the transmission-side TCP device and a receiving-side TCP device, the device comprising:
a plurality of first IP processing units that determine whether a packet transmitted from the transmission terminal is a TCP/IP packet transmitted in accordance with TCP/IP, and specify a session of TCP/IP in a case of a TCP/IP packet;
a first data queue in the transmission-side TCP device that accumulates the packet, determined to be a TCP/IP packet by the first IP processing unit, for each session;
a plurality of first TCP processing units that read out the packet accumulated in the first data queue in transmission-side TCP device, and perform TCP processing on the packet with the transmission terminal;
a second data queue in the transmission-side TCP device that accumulates transmission data, included in the packet on which the TCP processing has been performed by the first TCP processing unit, for each session;
a plurality of compression processing units in the transmission-side TCP device that read out the transmission data accumulated in the second data queue in the transmission-side TCP device, and perform compression processing on the transmission data;
a third data queue in the transmission-side TCP device that accumulates the transmission data, compressed by the compression processing unit in the transmission-side TCP device, for each session;
a plurality of second TCP processing units that read out the compressed transmission data accumulated in the third data queue in the transmission-side TCP device, and perform TCP processing with the receiving-side TCP device for transmitting the transmission data to the receiving-side TCP device;
a fourth data queue in the transmission-side TCP device that accumulates the transmission data, on which the TCP processing has been performed by the second TCP processing unit, for each session; and
a plurality of second IP processing units that generate a packet obtained by performing IP processing for transmitting the transmission data accumulated in the fourth data queue in the transmission-side TCP device to the receiving-side TCP device.

2. A receiving-side TCP device in a communication system in which transmission data which is transmitted using TCP/IP from a transmission terminal to a receiving terminal is transferred using a transmission-side TCP device and the receiving-side TCP device, the device comprising:
a plurality of third IP processing units that determine whether a packet transmitted from the transmission-side TCP device is a TCP/IP packet transmitted in accordance with TCP/IP, and specify a session of TCP/IP in a case of a TCP/IP packet;
a first data queue in the receiving-side TCP device that accumulates the packet, determined to be a TCP/IP packet by the third IP processing unit, for each session;
a plurality of third TCP processing units that read out the packet accumulated in the first data queue in the receiving-side TCP device, and perform TCP processing on the packet with the transmission-side TCP device;
a second data queue in the receiving-side TCP device that accumulates transmission data, included in the packet on which the TCP processing has been performed by the third TCP processing unit, for each session;
a plurality of decompression processing units in the receiving-side TCP device that read out the transmission data accumulated in the second data queue in the receiving-side TCP device, and perform decompression processing on the transmission data;
a third data queue in the receiving-side TCP device that accumulates the transmission data, decompressed by the decompression processing unit in the receiving-side TCP device, for each session;
a plurality of fourth TCP processing units that read out the decompressed transmission data accumulated in the third data queue in the receiving-side TCP device, and perform TCP processing with the receiving terminal for transmitting the transmission data to the receiving terminal;
a fourth data queue in the receiving-side TCP device that accumulates the transmission data, on which the TCP processing has been performed by the fourth TCP processing unit, for each session; and
a plurality of fourth IP processing units that generate a packet obtained by performing IP processing for transmitting the transmission data accumulated in the fourth data queue in the receiving-side TCP device to the receiving terminal.

3. A communication system comprising:
the transmission-side TCP device according to claim 1; and
the receiving-side TCP device according to claim 2.

4. The transmission-side TCP device according to claim 1, wherein the first TCP processing unit further creates proxy response data for performing a proxy response to the transmission terminal, and
the transmission-side TCP device further comprises:
a fifth data queue in the transmission-side TCP device that accumulates the proxy response data; and
a fifth IP processing unit that reads out the proxy response data accumulated in the fifth data queue in the transmission-side TCP device, and generates a packet obtained by performing IP processing for transmission to the transmission terminal.

5. A communication method in which transmission data which is transmitted using TCP/IP from a transmission terminal to a receiving terminal is transferred using a transmission-side TCP device and a receiving-side TCP device, the method comprising, in the following order:
a first IP processing procedure of causing the transmission-side TCP device to determine whether a packet transmitted from the transmission terminal is a TCP/IP packet transmitted in accordance with TCP/IP, specify a session of TCP/IP in a case of a TCP/IP packet, and to accumulate the packet determined to be a TCP/IP packet in a first data queue in the transmission-side TCP device for each session;
a first TCP processing procedure of causing the transmission-side TCP device to read out the packet accumulated in the first data queue in the transmission-side TCP device, perform TCP processing on the packet with the transmission terminal, and to accumulate transmission data, included in the packet on which the TCP processing has been performed, in a second data queue in the transmission-side TCP device for each session;
a compression processing procedure in the transmission-side TCP device of causing the transmission-side TCP device to read out the transmission data accumulated in the second data queue in the transmission-side TCP device, perform compression processing on the transmission data, and to accumulate the compressed transmission data in a third data queue in the transmission-side TCP device for each session;
a second TCP processing procedure of causing the transmission-side TCP device to read out the compressed transmission data accumulated in the third data queue in the transmission-side TCP device, perform TCP processing with the receiving-side TCP device for transmitting the transmission data to the receiving-side TCP device, and to accumulate the transmission data, on which the TCP processing has been performed, in a fourth data queue in the transmission-side TCP device for each session;
a second IP processing procedure of causing the transmission-side TCP device to generate a packet obtained by performing IP processing for transmitting the transmission data accumulated in the fourth data queue in the transmission-side TCP device to the receiving-side TCP device, and to transmit the packet to the receiving-side TCP device;
a third IP processing procedure of causing the receiving-side TCP device to determine whether a packet transmitted from the transmission-side TCP device is a TCP/IP packet transmitted in accordance with TCP/IP, specify a session of TCP/IP in a case of a TCP/IP packet, and to accumulate the packet determined to be a TCP/IP packet in a first data queue in the receiving-side TCP device for each session;
a third TCP processing procedure of causing the receiving-side TCP device to read out the packet accumulated in the first data queue in the receiving-side TCP device, perform TCP processing on the packet with the transmission-side TCP device, and to accumulate transmission data, included in the packet on which the TCP processing has been performed, in a second data queue in the receiving-side TCP device for each session;
a decompression processing procedure in the receiving-side TCP device of causing the receiving-side TCP device to read out the transmission data accumulated in the second data queue in the receiving-side TCP device, perform decompression processing on the transmission data, and to accumulate the decompressed transmission data in a third data queue in the receiving-side TCP device for each session;
a fourth TCP processing procedure of causing the receiving-side TCP device to read out the decompressed transmission data accumulated in the third data queue in the receiving-side TCP device, perform TCP processing with the receiving terminal for transmitting the transmission data to the receiving terminal, and to accumulate the transmission data, on which the TCP processing has been performed, in a fourth data queue in the receiving-side TCP device for each session; and
a fourth IP processing procedure of causing the receiving-side TCP device to generate a packet obtained by performing IP processing for transmitting the transmission data accumulated in the fourth data queue in the receiving-side TCP device to the receiving terminal, and to transmit the packet to the receiving terminal.
